(19) United States
(12) Patent Application Publication
(10) Pub. No.: US 2026/0253375 A1
(43) Pub. Date: Aug. 27, 2026

(54) ADAPTIVE ATTENTION SAMPLING OF DATA SEQUENCES FOR MACHINE LEARNING

(71) Applicant: Microsoft Technology Licensing, LLC, Redmond, WA (US)

(72) Inventors: Naoto USUYAMA, Sammamish, WA (US); Zhengde ZHAO, Redmond, WA (US); Hoifung POON, Redmond, WA (US); Joseph Samuel PRESTON, Seattle, WA (US); Mu-Hsin WEI, Bellevue, WA (US); Sid Hilmi KIBLAWI, Seattle, WA (US); Peter LEE, Hong Kong (CN)

(73) Assignee: Microsoft Technology Licensing, LLC, Redmond, WA (US)

(21) Appl. No.: 19/065,422

(22) Filed: Feb. 27, 2025

(51) Int. Cl. G06V 10/74; G06V 10/44; G06V 10/764

(52) U.S. Cl. CPC G06V 10/761; G06V 10/44; G06V 10/764

(57) ABSTRACT

This document relates to adaptive attention sampling of a data sequence. In the disclosed implementations, sparse attention is implemented by sampling from a probability distribution to select a subset of portions of the data sequence for attention processing. The attention sampling can be performed over multiple iterations, updating the sampling probabilities at each subsequent iteration. This allows attention processing to focus computational resources on relevant portions of a data sequence while utilizing fewer computational resources on relatively less-relevant portions of the data sequence.

### BACKGROUND

Machine learning models can employ attention techniques when analyzing a data sequence, such as a sequence of pixel patches in an image or a sequence of tokens in a text document. For instance, attention can guide a machine learning model to focus on relatively more relevant parts of the data sequence and less focus on relatively less relevant parts of the data sequence when performing a given task. However, attention techniques have some limitations, particularly when only a very small portion of a large data sequence is relevant to the task being performed by the machine learning model.

### SUMMARY

This Summary is provided to introduce a selection of concepts in a simplified form. These concepts are further described below in the Detailed Description. This Summary is not intended to identify key features or essential features of the claimed subject matter, nor is it intended to be used to limit the scope of the claimed subject matter.

The description generally relates to techniques for employing attention in a machine learning model. One example includes a computer-implemented method that can include receiving a prompt relating to a data sequence. The method can also include performing two or more iterations of: using a machine learning model, determining respective confidence scores that respective portions of the data sequence match the prompt, determining sampling probabilities for the respective portions based at least on the confidence scores, sampling a subset of the portions of the data sequence based at least on the sampling probabilities, and using the machine learning model, performing attention processing on the sampled subset of the portions of the data sequence, the attention processing influencing the confidence scores in a subsequent iteration. The method can also include, using the machine learning model, identifying a matching portion of the data sequence based at least on the confidence scores. The method can also include outputting the matching portion in response to the prompt.

Another example entails a system that includes a processor and a storage medium storing instructions. When executed by the processor, the instructions can cause the system to receive a prompt relating to a data sequence. The instructions can also cause the system to perform two or more iterations of: using a machine learning model, determine respective confidence scores that respective portions of the data sequence match the prompt, determine sampling probabilities for the respective portions based at least on the confidence scores, sample a subset of the portions of the data sequence based at least on the sampling probabilities, and using the machine learning model, perform attention processing on the sampled subset of the portions of the data sequence, the attention processing influencing the confidence scores in a subsequent iteration. The instructions can also cause the system to, using the machine learning model, identify a matching portion of the data sequence based at least on the confidence scores. The instructions can also cause the system to output the matching portion in response to the prompt.

Another example includes a computer-readable storage medium storing executable instructions which, when executed by a processor, cause the processor to perform acts. The acts can include receiving a prompt relating to a data sequence. The acts can also include performing two or more iterations of: using a machine learning model, determining respective confidence scores that respective portions of the data sequence match the prompt, determining sampling probabilities for the respective portions based at least on the confidence scores, sampling a subset of the portions of the data sequence based at least on the sampling probabilities, and using the machine learning model, performing attention processing on the sampled subset of the portions of the data sequence, the attention processing influencing the confidence scores in a subsequent iteration. The acts can also include, using the machine learning model, identifying a matching portion of the data sequence based at least on the confidence scores. The acts can also include outputting the matching portion in response to the prompt.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example transformer-based object segmentation model, consistent with some implementations of the present concepts.

FIG. 2 illustrates processing by an attention block of a machine learning model, consistent with some implementations of the present concepts.

FIG. 3 illustrates a pixel grounded mask aggregation module, consistent with some implementations of the present concepts.

FIG. 4 illustrates an example of iterative sampling of pixels from an image, consistent with some implementations of the present concepts.

FIGS. 5 and 6 illustrate experimental results, consistent with some implementations of the present concepts.

FIG. 7 illustrates an example of a system in which the disclosed implementations can be performed, consistent with some implementations of the disclosed techniques.

FIG. 8 illustrates an example of a method consistent with some implementations of the present concepts.

FIGS. 9A and 9B illustrate an example of iterative sampling of text, consistent with some implementations of the present concepts.

FIG. 10 illustrates an example of a backbone for image processing, consistent with some implementations of the present concepts.

FIG. 11 illustrates an example of a pixel decoder, consistent with some implementations of the present concepts.

FIG. 12 illustrates an example of a language encoder, consistent with some implementations of the present concepts.

### DETAILED DESCRIPTION

### Overview

As noted above, attention techniques can be employed to model long sequences of data. For instance, self-attention involves attending from one element of a data sequence to another element in that data sequence. On the other hand, cross-attention involves attending from elements in one data sequence to elements in another data sequence. The transformer architecture can employ both self-attention and cross-attention to model relationships among elements in one or more data sequences. This allows transformer-based models to perform very well at predictive tasks, such as classifying data, as well as generative tasks, such as generating text or images.

In some cases, a machine learning model can receive a prompt and then match the prompt to a portion of a data sequence. One way to identify the matching portion involves a dense cross-attention approach, where attention values are computed between the prompt and every element in the data sequence. However, when the matching portion of the data sequence is very small relative to the entire data sequence, dense cross-attention can result in wasteful computation of attention scores on irrelevant portions of the data sequence.

For instance, consider segmentation of objects from images based on a prompt specifying the object to be segmented from the image. By using cross-attention between the prompt and pixels in the image, segmentation models can identify objects in images that match the prompt. However, segmentation models still tend to perform poorly for very small objects, in part because the models attend equally to all pixels in the image even though only a very small number of pixels need to be identified for the segmentation. Thus, most attention computation is performed on irrelevant pixels that are not near the object of interest. A similar problem can arise in natural language processing context, when a prompt is matched to a large text sequence (e.g., a large document or corpus of multiple documents), because it can be impractical to compute attention scores for the token(s) of the prompt and all tokens in the text sequence.

The disclosed implementations offer techniques for employing adaptive attention sampling techniques that focus attention computations on areas of a data sequence that are likely to match a prompt. For instance, the disclosed techniques can determine sampling probabilities for different portions of the data sequence based on confidence that individual portions match the prompt. A subset of the portions of the data sequence can be selected for attention processing (e.g., computing cross-attention scores).

The sampling probabilities and attention processing can be performed over multiple iterations, at which point a final matching portion of the data sequence can be identified.

### Machine Learning Overview

There are various types of machine learning frameworks that can be trained to perform a given task. Support vector machines, decision trees, and neural networks are just a few examples of machine learning frameworks that have been used in a wide variety of applications, such as image processing, computer vision, and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

The term “data sequence,” as used herein, refers to a sequence of multiple data elements. For example, a data sequence could include pixels or patches of pixels, text or natural language tokens, audio samples, video frames, etc. The term “prompt” refers to data that can be used to identify a matching portion of a data sequence. For instance, in some cases the prompt is in the same modality as the data sequence, e.g., a natural language prompt used to identify a matching portion from a natural language document. In other cases, the prompt is in a different modality than the data sequence, e.g., a natural language prompt that is used to identify a matching object from patches of pixels in an image.

The term “machine learning model” refers to model that is trained using training data to adjust parameters of the model. The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Object Segmentation Model

As noted above, the disclosed techniques can be employed to adaptively focus attention computations on high-probability portions of a data sequence. The following describes a specific transformer-based object segmentation model that shows how the present concepts can be applied for image segmentation. Subsequently, additional examples are provided illustrating how adaptive attention techniques can be applied to other types of data besides images, e.g., by matching a query to a text sequence.

The transformer-based object segmentation model receives an input image and a natural language description (e.g., a text prompt) of an object of interest. The transformer-based object segmentation model performs end-to-end detection and segmentation of the object specified by the text prompt. An annealing schedule that uses a probability distribution with a temperature parameter (e.g., a Boltzmann distribution) is employed to select areas of the input image to sample from. At higher temperatures, the model samples relatively random areas from across the entire image. As the temperature cools, the model starts to focus attention on areas of the image that are more likely to include the object specified by the text prompt.

As described more below, the model can encode the image to extract visual features at multiple scales, as well as a semantic map. Then, latent query vectors are learned together with the image representation and text embeddings. Multiple transformer-based layers, augmented by an adaptive sampling module, iteratively process these values, with each subsequent layer focusing more on high-probability areas of the image. In the final layer, the latent query vectors are combined with the image representation to generate candidate segmentation masks. The candidate segmentation masks are aggregated to produce a final segmentation mask for the object specified by the text prompt.

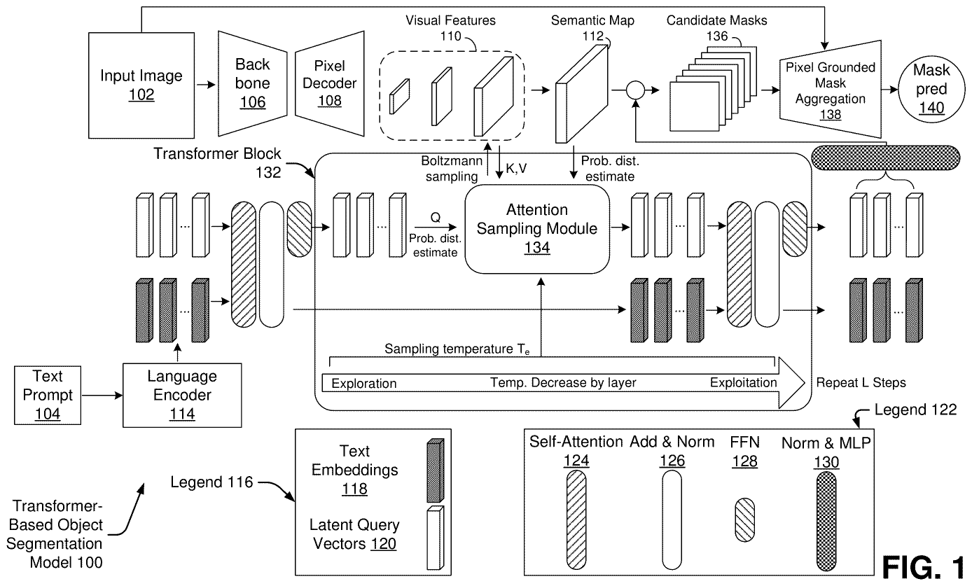

FIG. 1 illustrates components of transformer-based object segmentation model 100 for end-to-end object detection by segmentation based on a text prompt. An input image 102 and a text prompt 104 are input to the transformer-based object segmentation model, and processed as follows.

The input image 102 is provided to a backbone 106 and then a pixel decoder 108 to obtain visual features 110 and a semantic map 112. The text prompt 104 is input to a language encoder 114. As shown in legend 116, the text encoder produces text embeddings 118. The text embeddings and latent query vectors 120 are processed using a series of neural network layers as shown in legend 122, such as self-attention layer(s) 124, add & norm layer(s) 126, feed-forward network (FFN) layer(s) 128, and normalization and multilayer perceptron (MLP) layer(s) 130.

A transformer block 132 includes an attention sampling module 134 that dynamically proposes sparse areas of the input image on which to focus cross-attention using a probability distribution (e.g., a Boltzmann distribution). As described more below, multiple transformer blocks can be employed for successive layers of the model. To account for uncertainty, which can be high in earlier stages of computation, the attention sampling module starts with a high temperature in the first layer, which gradually cools down in subsequent layers. The attention sampling can be viewed from a reinforcement learning perspective, where exploration is favored in the initial layers (more sparse areas being sampled), and exploitation is favored in later layers (focusing on a handful of most promising areas).

Multiple successive transformer blocks can be provided as separate, successive layers of the transformer-based object segmentation model 100. At each layer, latent query vectors 120 are combined with the semantic map 112 to produce a probability distribution over the image, which is then used by the attention sampling module 134 to sample the sparse areas. The latent query vectors each attend exclusively to the visual features 110 in the sampled area and update themselves. The latent query vectors communicate with the text embeddings through self-attention, and then the laten queries are combined with the semantic map 112 to generate candidate masks 136. The candidate masks are aggregated by a pixel grounded mask aggregation or PiGMA module 138 into the final mask prediction 140.

### Transformer Block Details

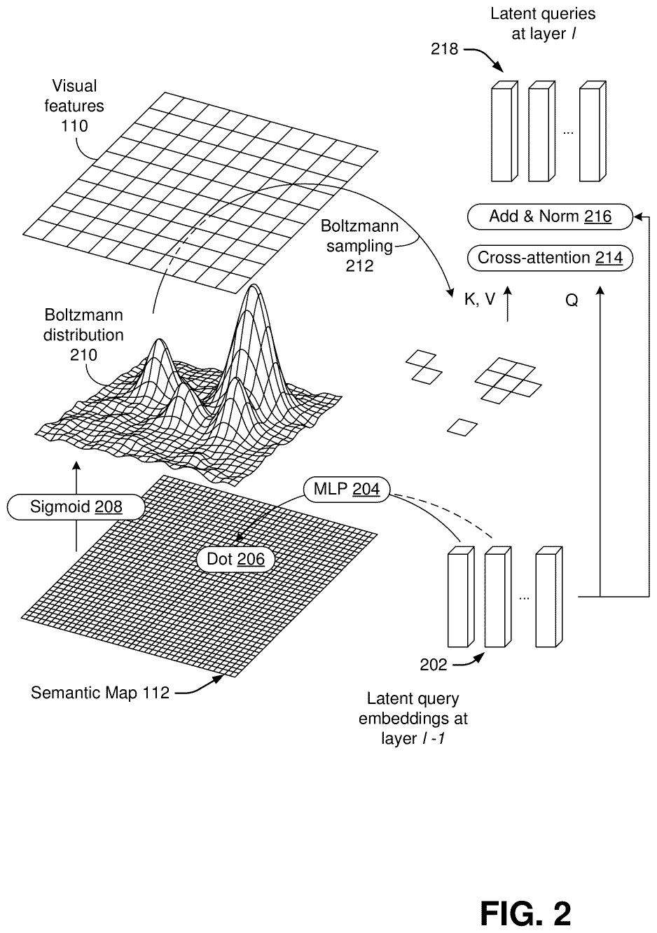

FIG. 2 illustrates additional details relating to transformer block 132. Latent query vectors 202 from the previous layer each go through an MLP transformation 204, as described below with respect to Eq. (3). The dimensions are kept constant. The resulting transformed latent query vector is processed using a dot product 206 with all feature vectors on the semantic map 112, yielding scalars on the map. A sigmoid function 208 is used transform the scores into the range (0,1), and a Boltzmann distribution 210 is computed using a temperature parameter τl according to Eq. (5) set forth below. Boltzmann sampling 212 is performed from corresponding patches of visual features 110 for N trials with replacement. Each latent query vector attends exclusively to the sampled patches via cross-attention operation 214. Add & norm layer 216 adds the result of the cross-attention operation to the corresponding latent query vector from the previous layer and performs layer normalization on the result, resulting in latent query vectors 218 that are output by the current layer.

### PiGMA Module Details

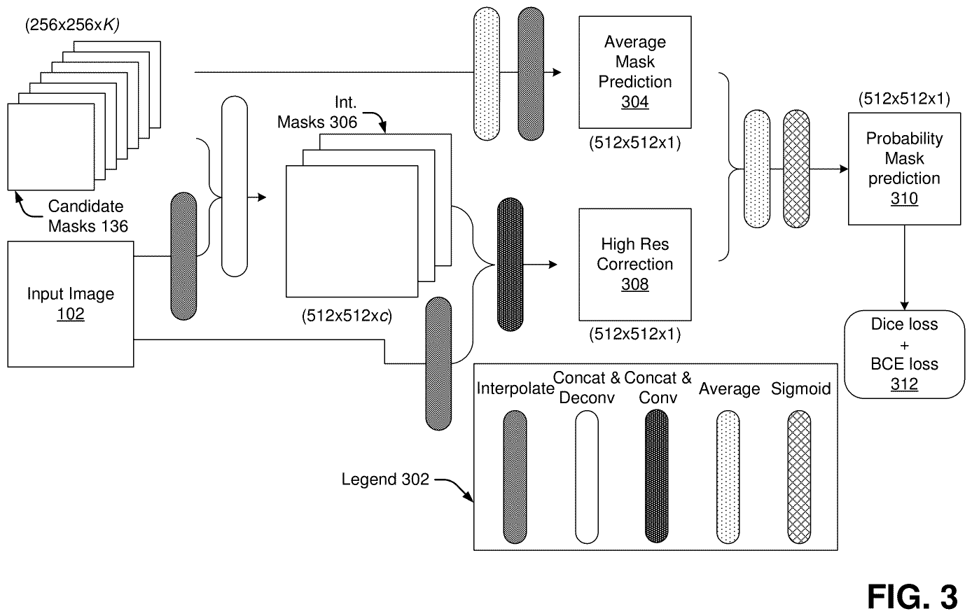

FIG. 3 illustrates additional details relating to PiGMA module 138, where legend 302 identifies respective layers of the PiGMA module. The PiGMA module receives candidate masks 136 (e.g., K masks at 256×256 resolution each) after the last transformer block 132 completes, as well as input image 102 (e.g., raw pixels at original resolution). The candidate masks can be averaged and interpolated to a higher resolution (e.g., 512×512) to obtain an average mask prediction 304. The candidate masks 136 can be resized by deconvolution to obtain intermediate masks 306. The input image can be interpolated (e.g., to 512×512 resolution) and processed using one or more convolutions, concatenated on the channel dimension with the intermediate masks to obtain a high resolution correction 308. In FIG. 3, c is the intermediate convolution dimension. Finally, the average mask prediction 304 and the high resolution correction 308 are averaged and passed through a sigmoid transformation to produce a pixel-wise probability mask prediction 310 according to a loss function 312 (e.g., Dice loss+binary cross-entropy loss).

### Sampling Example

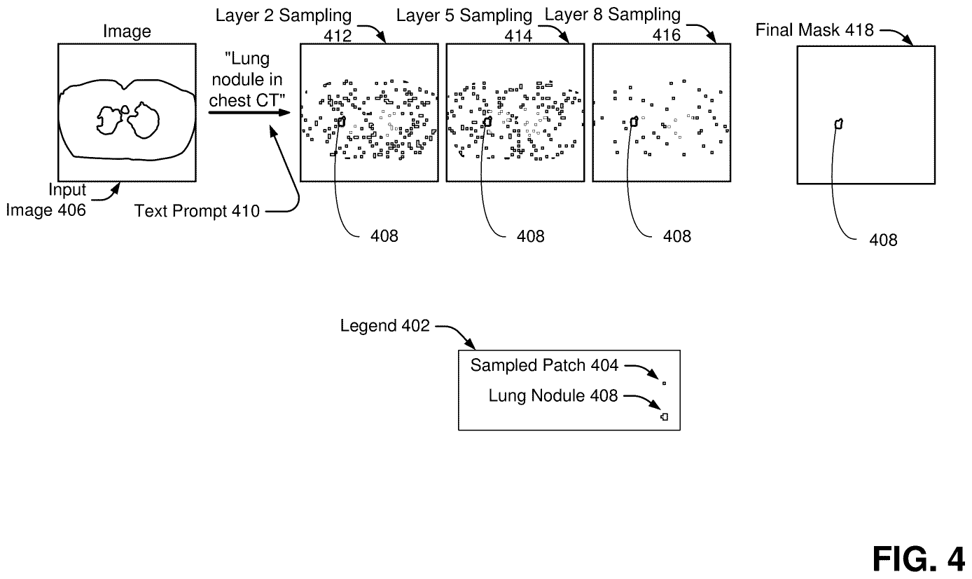

FIG. 4 illustrates an example of how attention-based sampling can proceed over multiple iterations to gradually focus on more relevant portions of an image. Legend 402 shows where sampled patches 404 are selected from an input image 406 to identify a lung nodule 408 over multiple sampling iterations.

Input image 406 is input with a text prompt 410, which requests finding a “lung nodule in chest CT.” Sampling can proceed through multiple layers (e.g., successive instances of transformer block 132). The patches selected by the attention sampling module for cross-attention processing at several layers are shown in FIG. 4—layer 2 sampling 412, layer 5 sampling 414, and layer 8 sampling 416. Also shown is a final mask 418 that segments out the lung nodule.

Thus, as can be seen in FIG. 4, the sampling progresses by focusing less on regions of the input image 406 that are relatively unlikely to include the lung nodule 408, and more on regions of the input image that are relatively more likely to include the lung nodule. As a consequence, at each subsequent layer, attention computations are focused on relatively more relevant regions of the input image. As a result, it is possible to accurately identify a very small object in the input image in a computationally-efficient manner.

### Mathematical Details

The following describes additional mathematical details on transformer-based object segmentation model 100, shown in FIG. 1 and described briefly above. The model utilizes a pixel decoder that takes in image features from a backbone, and text embeddings provided by a language encoder. The output of the model is a mask, e.g., a binary segmentation of pixels in the input image.

The transformer-based object segmentation model 100 performs the pixel-wise binary classification by predicting whether each pixel of the input image belongs to the text prompt semantics or not. One specific technique that can be employed to encode the input image is to employ a backbone 106 followed by a pixel decoder 108. (Cheng, et al., “Masked-Attention Mask Transformer for Universal Image Segmentation,” Proceedings of the IEEE/CVF Conference on Computer Vision and Pattern Recognition, 2022, pp. 1290-1299). This results in visual features

$${V}^{( λ )} ∈ {ℝ}^{\frac{H}{λ} \times \frac{W}{λ} \times d}$$

with different down-sampling factors λ. A semantic map S∈ [symbol] ^{H×W×d} can be derived from the multiscale visual features to represent the unified image semantics. The text prompt is encoded into a sequence of text embeddings T∈ [symbol] ^{N}^{_{T}}^{×d}. Each pixel is classified each pixel (x, y) with

$${U}_{xy} ( μ ) = sigmoid ( {μ}^{T} {S}_{xy} ) , \qquad ( 1 )$$

where the μ∈ [symbol] ^{d} vector is found by the model as a function [symbol] of the image and text features

$$μ = ℬ ( V , S , T ) . \qquad ( 2 )$$

The following shows how the transformer-based object segmentation model 100 finds a μ vector based on all the image and text features. The model finds the μ vector by finding a latent query vector q∈ [symbol] ^{d}, which maps to μ through a nonlinear MLP transformation

$$μ = MLP ( q ) . \qquad ( 3 )$$

In some implementations, instead of using a single latent query vector q, an ensemble of m latent queries is initiated, forming Q=[q⁽¹⁾, . . . , q^{(m)}]. Each query yields its own prediction at the end. The ensemble approach reduces uncertainty, as Boltzmann sampling is a stochastic process.

Prior to taking any input from the image, the latent query Q₀ can be conditioned on the text embedding T:

$${Q}_{0} = FFN ( LayerNorm ( [ Q , T ] + SelfAttn [ Q , T ] ) ) , \qquad ( 4 )$$

where Q is a learnable initial query matrix. Then, [Q, T] can be concatenated before performing self-attention, and split out only the Q part before the feed-forward network layer FFN. The same operation applies to following [Q, T] self-attention blocks.

Attention Sampling. The latent queries then go through L layers of attention blocks (e.g., transformer blocks) where the queries [symbol] sample information from the visual features to update themselves. Each Boltzmann sampling is followed by a self-attention layer for each latent query to attend to others and to the text embeddings, as described more below.

Step 1. Boltzmann distribution. Given the query

$${q}_{ℓ}^{( i )}$$

at layer [symbol] , first use it to compute the Boltzmann distribution on the image, which is a probability field

$${p}_{xy} ( {q}_{l}^{( i )} ) = \frac{exp ( {U}_{xy} ( MLP ( {q}_{ℓ}^{( i )} ) ) / {τ}_{ℓ} )}{{\int }_{{x}^{′} {y}^{′}} exp ( {U}_{{x}^{′} {y}^{′}} ( MLP ( {q}_{ℓ}^{( i )} ) ) / {τ}_{ℓ} )} . \qquad ( 5 )$$

Apply the same MLP transformation in Eq. (3), and the pixel confidence estimator Eq. (1). The integral is on all (x′, y′) on the image field to normalize the distribution. Note that a continuous form is employed here to efficiently consider different scales of image features. The discrete distribution can be obtained through grid interpolation in some implementations.

Based on Eq. (5), areas with higher confidence scores U_{xy} are assigned higher sampling probabilities. The sampling temperature [symbol] controls the concentration of the distribution in high-confidence areas. As layer [symbol] increases, the temperature is gradually decreased according to [symbol] =τ₀/(1+ [symbol] ), where τ₀ is the temperature at the base layer [symbol] =0. Exploration across the entire image is encouraged in the early layers and progressively shift towards exploitation of the most confident regions.

Step 2. Random attention sampling. Next, sample from the visual features V^{(λ)} according to the Boltzmann distribution

$${p}_{x y} ( {q}_{ℓ}^{( i )} )$$

estimated by query

$${q}_{ℓ}^{( i )} .$$

(In each layer, one of the visual feature scale λ is utilized). As V^{(λ)} forms a down-sampled grid on the image, first interpolate

$${p}_{x y} ( {q}_{ℓ}^{( i )} )$$

to assign probability for each patch, drawing from the distribution over the patches for N independent trials. The union of the sampled patches forms an attention set

$${𝒜}_{ℓ}^{( i )} .$$

Since one patch can be sampled multiple times, the total size of the sampled set satisfies

$$\vert {𝒜}_{ℓ}^{( i )} \vert \leq N .$$

Each query vector

$${q}_{ℓ}^{( i )}$$

then exclusively attends to the visual features in the sampled region and adds to itself. In the multi-head cross-attention, the attention score on the image for each head j is calculated as

$${α}_{x y}^{j} = \frac{exp ( {W}_{j}^{Q} {q}_{ℓ}^{( i )} \cdot {W}_{j}^{K} {V}_{x y}^{( λ )} / d )}{{Σ}_{( {x}^{′} , {y}^{′} ) ∈ {𝒜}_{ℓ}^{( i )}} exp ( {W}_{j}^{Q} {q}_{ℓ}^{( i )} \cdot {W}_{j}^{K} {V}_{{x}^{′} {y}^{′}}^{( λ )} , / d )}$$

for

$$( x , y ) ∈ {𝒜}_{ℓ}^{( i )} ,$$

and 0 elsewhere. The output of head j attention is

$${H}_{j} = {\sum }_{( {x}^{′} , {y}^{′} ) ∈ {𝒜}_{ℓ}^{( i )}} {α}_{{x}^{′} {y}^{′}}^{j} {W}_{j}^{V} {V}_{{x}^{′} {y}^{′}}^{( λ )} .$$

The query is then updated by combining the heads and adding to itself:

$${q}_{ℓ + 1}^{( i )} = {q}_{ℓ}^{( i )} + [ {H}_{1 ,} ⋯ , {H}_{h} ] {W}^{O} .$$

This process can be applied for all query vectors

$${q}_{ℓ}^{( 1 )} , ⋯ , {q}_{ℓ}^{( m )} ,$$

followed by a layer normalization on the updated query ensemble before advancing to the next step.

Step 3. Inter-query attention. After all the queries go through the Boltzmann attention sampling process, a self-attention block is applied such that the information is shared among themselves and with the text embeddings:

$$FFN ( LayerNorm ( [ {Q}_{ℓ + 1} , {T}_{ℓ} ] + SelfAttn [ {Q}_{ℓ + 1} , {T}_{ℓ} ] ) ) . \qquad ( 6 )$$

Again, split out the Q part before going through the feed-forward network layer. Here [symbol] is the text embedding from the previous layer. The updated query embeddings and text embeddings are fed into the next attention block.

PiGMA Query Aggregation. After L blocks of attention sampling, obtain m finalized latent query vectors

$${q}_{L}^{( 1 )} , … , {q}_{L}^{( m )} .$$

By applying the MLP transformation in Eq. (3) and estimating pixel-wise confidence score using Eq. (1), each query yields a mask prediction. The PiGMA module illustrated in FIG. 2 is employed to aggregate the mask predictions from multiple queries. The aggregated prediction combines the following two components.

Query Ensemble Prediction. As the m predicted masks are the final pixel-wise confidence estimation, this component is the average of the mask predictions:

$$M = \frac{1}{m} {\sum }_{i = 1}^{m} M L P ( {q}_{L}^{( i )} ) \cdot S . \qquad ( 7 )$$

Pixel-Grounded Correction. To address the intrinsic randomness in the query predictions, a lightweight two-layer convolutional network is applied to the mask predictions, grounding on the original image pixels to give a high-resolution correction to the ensemble prediction.

The final output from PiGMA is the average of these two components. A pixel-wise sigmoid transformation is applied to obtain a probabilistic mask prediction. The final mask prediction is supervised using the sum of the Dice loss (Milletari, et al., V-net: Fully Convolutional Neural Networks for Volumetric Medical Image Segmentation,” 2016 Fourth International Conference on 3D Vision (3DV), October 2016, pp. 565-571) and binary cross-entropy loss.

The techniques described herein progressively reduce the size of the attention region by first “guessing” on a learnable probability distribution. Each “guess” does not need to be perfect, as there are multiple queries and rounds. The more relevant features in each sampled set will be picked out by the cross-attention operation, and shifts the updated query to focus more on those regions. Compared to standard attention, which tries to focus on the desired feature only through optimizing on the massive number of tokens, sampling plus attention relieves the learning burden when the target region is very small.

At each subsequent round of processing, the features sampled in the previous round that are more relevant will be amplified through cross-attention. As the attention output is added to the original query vector, the next round's Boltzmann distribution, estimated by the updated query vector, will focus more on the relevant features. Based on this mechanism, it can be beneficial to spread out the sampling distribution in the early layers, reducing the likelihood of omitting any relevant features. The annealing temperature scheduling is designed to balance the exploration and exploitation.

The ensemble of multiple queries not only diversify the exploration in Boltzmann sampling, but also boosts the final performance by their inter-communication through the self-attention layers. Once one of the queries get closer to the desired feature, other queries can update towards the desired state.

### Experimental Results

The following describes various experimental results that were obtained using the concepts described herein. The term BoltzFormer is used to refer to specific model(s) that were implemented consistently with the disclosed concepts and employed to conduct the experiments described herein. The experiments were conducted on seven public image segmentation datasets from Medical Segmentation Decathlon (MSD) (Antonelli, et al., “The Medical Segmentation Decathlon,” Nature Communications, 2022, 13(1), 4128), LIDC-IDRI (Armato III, et al., “The lung image database consortium (LIDC) and image database resource initiative (IDRI): a completed reference database of lung nodules on CT scans,” Medical Physics, 2011, 38(2), 915-931) and Amos22 (Ji, et al., “Amos: A large-scale abdominal multi-organ benchmark for versatile medical image segmentation,” Advances in neural information processing systems, 2022, 35, 36722-36732). The experiments used the GPT-4 enriched data from Zhao, et al., “BiomedParse: a biomedical foundation model for image parsing of everything everywhere all at once,” 2024, arXiv preprint arXiv:2405.12971 to evaluate text prompt segmentation for the targets in these datasets. Each of these datasets contains segmentation object types that are smaller than 1% of the image size in terms of area. The total benchmark suite covers a wide range of object sizes from below 0.002% to over 20% of image area, crossing four orders of magnitude.

Baselines. BoltzFormer was compared with three categories of baseline implementations. Segmentation FM decoder comparison: The following employ transformer decoder architectures in promptable image segmentation foundation models: SAM (Kirillov, et al., “Segment anything,” Proceedings of the IEEE/CVF International Conference on Computer Vision, 2023, pp. 4015-4026), SEEM (Zou, et al., “Segment everything everywhere all at once,” Advances in Neural Information Processing Systems, 2024, 36), and the recent SAM 2 (Ravi, et al., “Sam 2: Segment anything in images and videos,” 2024, arXiv preprint arXiv:2408.00714) (image version). To compare with BoltzFormer in the same text prompt setting, a customized SAM and SAM 2 was employed to take in text embeddings using UniCL (Yang, et al., “Unified contrastive learning in image-text-label space,” Proceedings of the IEEE/CVF Conference on Computer Vision and Pattern Recognition, 2022, pp. 19163-19173) as the language encoder. For the image backbone, Hiera was employed (Ryali, et al., “Hiera: A hierarchical vision transformer without the bells-and-whistles,” International Conference on Machine Learning, July 2023, pp. 29441-29454), (Bolya, et al., “Window Attention is Bugged: How not to Interpolate Position Embeddings,” 2023, arXiv preprint arXiv:2311.05613) model with masked autoencoder (MAE) pre-training (He, et al., “Masked autoencoders are scalable vision learners,” Proceedings of the IEEE/CVF conference on computer vision and pattern recognition, 2022, pp. 16000-16009), following the implementation in SAM 2 (Ravi, et al., “Sam 2: Segment anything in images and videos,” 2024, arXiv preprint arXiv:2408.00714). The decoders were compared in settings with different backbone configurations (Hiera-S and Hiera-BP). To test the compatibility of BoltzFormer with different backbone architectures, an additional experiment was implemented using the Focal-L (Yang, et al., “Focal modulation networks,” Advances in Neural Information Processing Systems, 2022, 35, 4203-4217) backbone pre-trained in SEEM. The pixel decoder architecture follows Cheng, et al., “Masked-attention mask transformer for universal image segmentation,” Proceedings of the IEEE/CVF conference on computer vision and pattern recognition, 2022, pp. 1290-1299, Zou, et al., “Segment everything everywhere all at once,” Advances in Neural Information Processing Systems, 2024, 36, and Zou, et al., “Generalized decoding for pixel, image, and language,” Proceedings of the IEEE/CVF Conference on Computer Vision and Pattern Recognition, 2023, pp. 15116-15127). For all decoder-backbone combinations, the models were trained the entirety of the benchmark suite.

Pre-trained foundation model comparison: The weights of the state-of-the-art biomedical image foundation model BiomedParse (Zhao, T., Gu, Y., Yang, J. et al. A foundation model for joint segmentation, detection and recognition of biomedical objects across nine modalities. Nat Methods 22, 166-176 (2025)) were used for comparison. BiomedParse takes in text prompt and performs segmentation for objects in medical images. The model was not further fine-tuned exclusively on the benchmark suite in this paper.

Expert model comparison: nnU-Net was employed (Isensee, et al., “nnU-Net: a self-configuring method for deep learning-based biomedical image segmentation,” Nature methods, 2021, 18(2), 203-211) as the expert model baseline. Individual expert nnU-Net models were trained for every object type in each datasets, resulting in 35 binary semantic segmentation models in total.

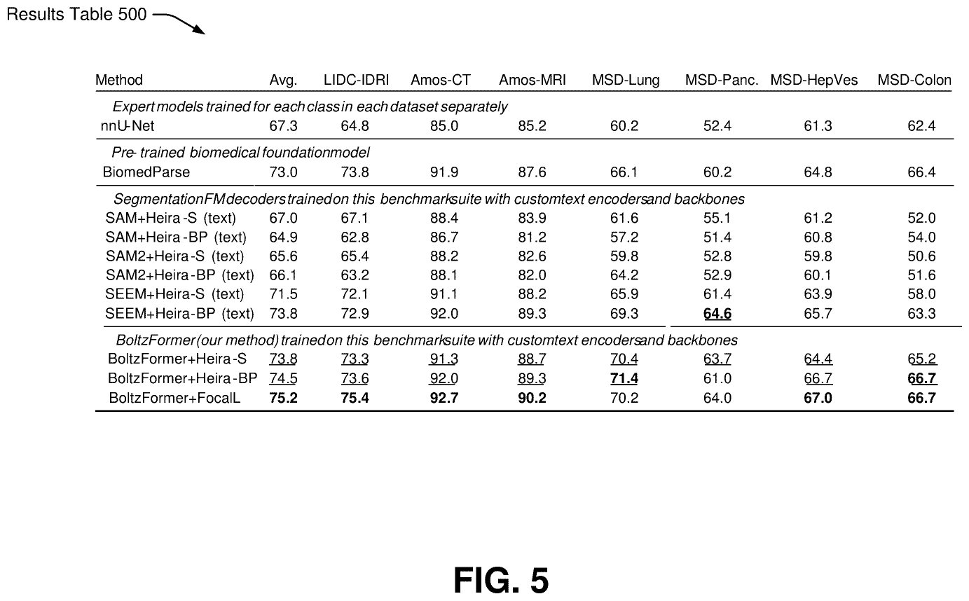

As shown in FIG. 5, results table 500 shows the Dice score evaluation of BoltzFormer compared with all the baseline models. Holding the image backbone constant, BoltzFormer outperformed all other segmentation FM decoders in mean Dice score averaged across the benchmark suite. The average performance improvements against the baseline decoders are: 12.4% against SAM, 12.6% against SAM 2, and 2.1% against SEEM. On individual benchmarks, BoltzFormer won over all baselines in most cases. In pre-trained model comparison, BoltzFormer outperformed BiomedParse on average and on each individual dataset. BoltzFormer also outperformed nnU-Net with 35 task-specific expert models. Lastly, BoltzFormer on the FocalL backbone shows dominant performance across the benchmark suite.

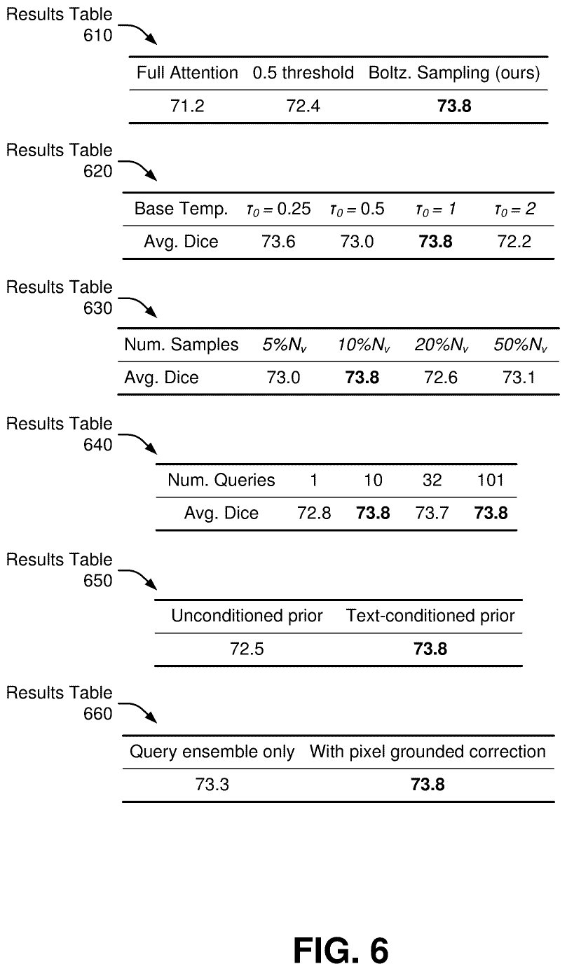

To show the effectiveness of Boltzmann attention sampling in attention masking, it was compared with the standard full attention, as well as fixed threshold masking following Cheng, et al., “Masked-attention mask transformer for universal image segmentation,” Proceedings of the IEEE/CVF conference on computer vision and pattern recognition, 2022, pp. 1290-1299, and Zou, et al., “Segment everything everywhere all at once,” Advances in Neural Information Processing Systems, 2024, 36. As shown in FIG. 6, results table 610 shows the average Dice score evaluated across the benchmark suite, where Boltzmann attention sampling showed significant advantage over full attention and fixed threshold masking.

Temperature is useful balancing exploration vs. exploitation and controlling the annealing behavior. As shown in results table 620, experiments were performed with different base temperatures in the layer-decay formula

$${τ}_{ℓ} = \frac{{τ}_{0}}{ℓ + 1} .$$

The results show that a balanced value τ₀=1 yielded the best performance. The performance dropped significantly when the temperature is too high, as the model explored for too long and couldn't exploit the most relevant features.

Experiments were conducted with the number of samples drawn by each query in each layer, measured as a percentage of the total number of visual features Nᵥ in that layer. As shown in results table 630, note that with as few as 5% features BoltzFormer is able to deliver satisfactory performance, and 10% sampling gave the best performance. Further increasing the sample size did not help with the model performance.

Another factor influencing performance of BoltzFormer is the design of multiple queries which perform independent distribution estimation and sampling. The self-attention layer after each Boltzmann attention sampling layer communicates the useful features across the ensemble. As shown in results table 640, note that as few as 10 queries is enough for best performance, and there was no notable difference when further increasing the number of queries. When there is no ensemble (only 1 query) the performance dropped notably.

The self-attention layer before the first Boltzmann attention sampling block helps the queries to initialize based on the semantic from the text prompt. Results table 650 illustrates the performance gain from text-conditioning (Eq. (4)).

The PiGMA module at the end of the model provides a nonlinear aggregation of the different predictions from the multiple queries by grounding on the original image. Results table 660 shows the improvement from pixel grounded correction.

### Example System

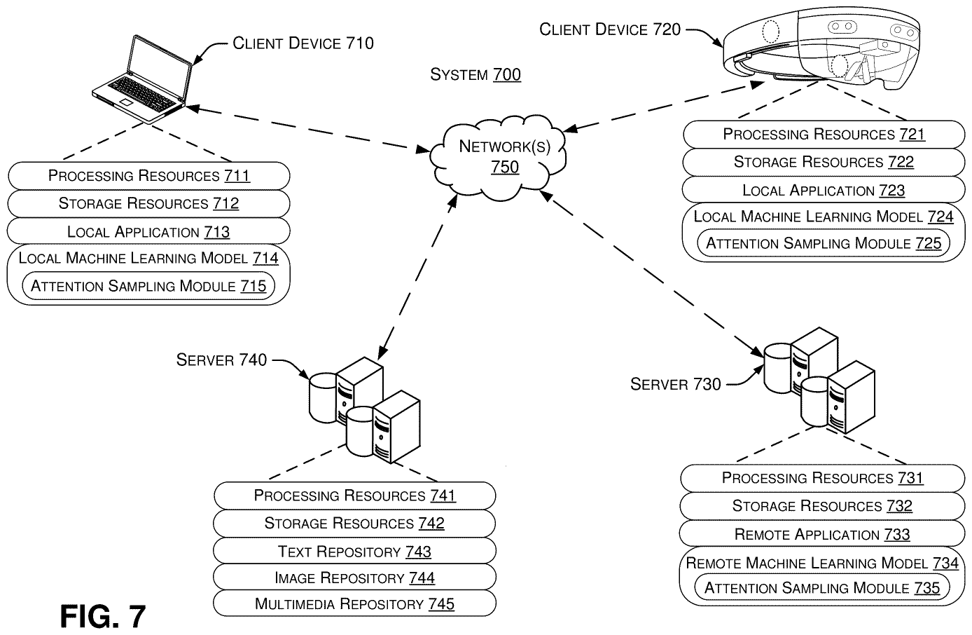

The present implementations can be performed in various scenarios on various devices. FIG. 7 shows an example system 700 in which the present implementations can be employed, as discussed more below.

As shown in FIG. 7, system 700 includes a client device 710, a client device 720, a server 730, and a server 740, connected by one or more network(s) 750. Note that the client devices can be embodied as a mobile device such as smart phones or tablets, stationary devices such as desktops, virtual or augmented reality headsets, etc. Likewise, the servers can be implemented using various types of computing devices. In some cases, any of the devices shown in FIG. 7, but particularly the servers, can be implemented in data centers, server farms, etc.

Client device 710 can have processing resources 711 and storage resources 712, client device 720 can have processing resources 721 and storage resources 722, server 730 can have processing resources 731 and storage resources 732, and server 740 can have processing resources 741 and storage resources 742. Each of these devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 710 can include one or more local application(s) 713 and a local machine learning model 714 with an attention sampling module 715. Client device 720 can include one or more local applications 723 and a local machine learning model 724 with an attention sampling module 725. Server 730 can include one or more remote application(s) 733 and a remote machine learning model 734 with an attention sampling module 735. Server 740 can host a text repository 743, an image repository 744, and/or a multimedia repository 745.

The local and remote machine learning models can utilize adaptive attention sampling as described elsewhere herein. For instance, in one example, the local and/or remote machine learning models are implemented as instances of transformer-based object segmentation model 100. For example, the local application 713 on client device 710 could allow a user to download an image from image repository 744 on server 740. The user of the client device could then process the image locally to match a text prompt to the image using local machine learning model 714. As another example, the local application could have local image storage and use the local machine learning model to match text to locally-stored images. As another example, the client device could send local or downloaded images to server 730 to find one or more objects in the images matching a text prompt.

In another use case, local application 723 on client device 720 can be an augmented or virtual reality application. The client device 720 can capture images of the physical environment. The local learning model 724 can be implemented as an instance of transformer-based object segmentation model 100. The user can speak the name of an object in the environment that the user wishes to find (e.g., lost keys). The local application can convert the user's speech to text, prompt the local machine learning model to segment the lost keys out of the image of the environment, and then highlight the keys to the user.

In other use cases, the local or remote applications can analyze text from local documents and/or text repository 743. For instance, the local or remote machine learning models can implement adaptive attention processing as described herein to perform cross-attention or self-attention on sequences of text. Additional examples of text processing are described below. As another example, the local or remote applications can allow users to search for specific objects in frames of video or specific sounds in frames of audio from local multimedia files and/or multimedia files hosted by multimedia repository 745 on server 740.

### Example Method

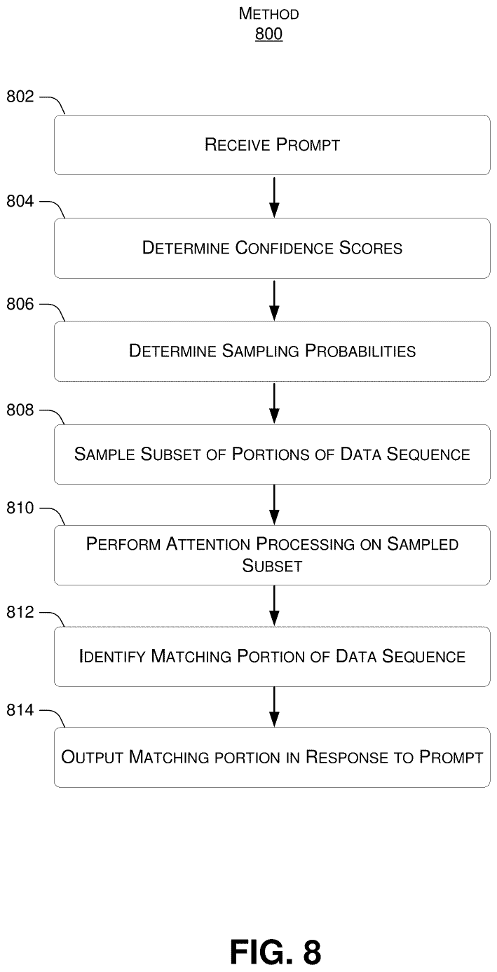

FIG. 8 illustrates an example computer-implemented method 800, consistent with some implementations of the present concepts. Method 800 can be implemented on many different types of devices, e.g., by one or more cloud servers, by a client device such as a laptop, tablet, or smartphone, or by combinations of one or more servers, client devices, etc.

Computer-implemented method 800 begins at block 802, where a prompt is received relating to a data sequence. For instance, the prompt can be a text prompt, spoken words, etc. The data sequence can be an image, a natural language document, a multimedia file, etc.

Computer-implemented method 800 continues at block 804, where a machine learning model is used to determine confidence scores. For instance, the confidence scores can indicate likelihoods that respective portions of the data sequence match the prompt. For instance, the confidence scores can indicate the likelihood that a given patch of an image matches a text prompt, that a given word of a document matches a text prompt, etc.

Computer-implemented method 800 continues at block 806, where sampling probabilities are determined. For instance, the sampling probabilities can be based on the confidence scores. Thus, for instance, the sampling probabilities can be relatively higher for portions of the data sequence with higher confidence scores, and relatively lower for other portions of the data sequence with relatively lower confidence scores.

Computer-implemented method 800 continues at block 808, where a subset of portions of the data sequence are sampled. For instance, random numbers can be generated and individual portions of the data sequence are selected based on the random numbers and the associated sampling probabilities of each portion.

Computer-implemented method 800 continues at block 810, where the attention processing is performed on the sampled subset. For instance, as described above, the attention processing can involve cross-attention calculations from two different data sequences. In some implementations, the different data sequences are from different modalities, e.g., a text prompt and an image. In other implementations, the different data sequences are from the same modality, e.g., matching a text prompt to a matching sentence of a document or matching an example image to a specific portion of a larger image or video being searched.

Computer-implemented method 800 continues at block 812, where a matching portion of the data sequence is identified based on the confidence scores. For instance, in some cases the matching portion can be identified using a bounding box or mask around an object in an image that matches a text prompt. In other cases, the matching portion could be identified as a matching sentence from a document, etc.

Computer-implemented method 800 continues at block 814, where the matching portion of the data sequence is output in response to the prompt. For instance, some implementations may highlight or zoom in on a particular matching object from an image. Other implementations can scroll to a specific page of a document that matches a prompt, and highlight or bold the specific text that is determined to match the prompt.

### Additional Implementations

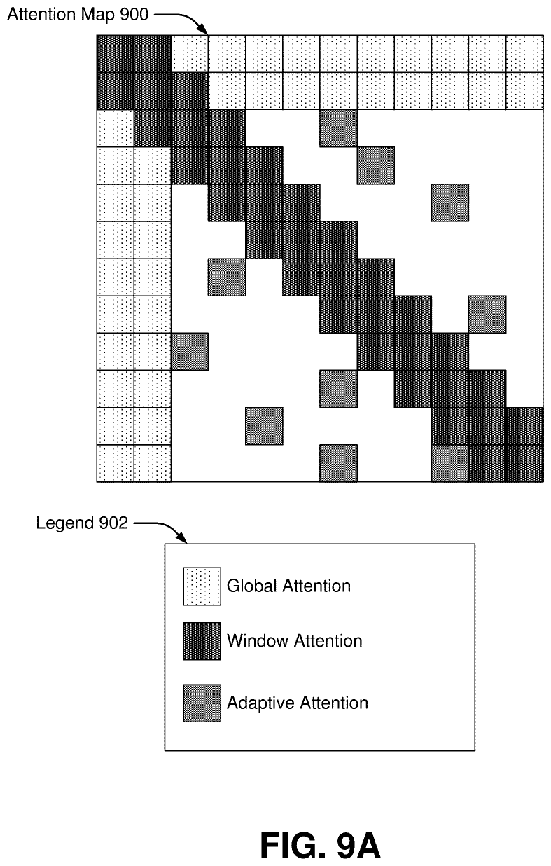

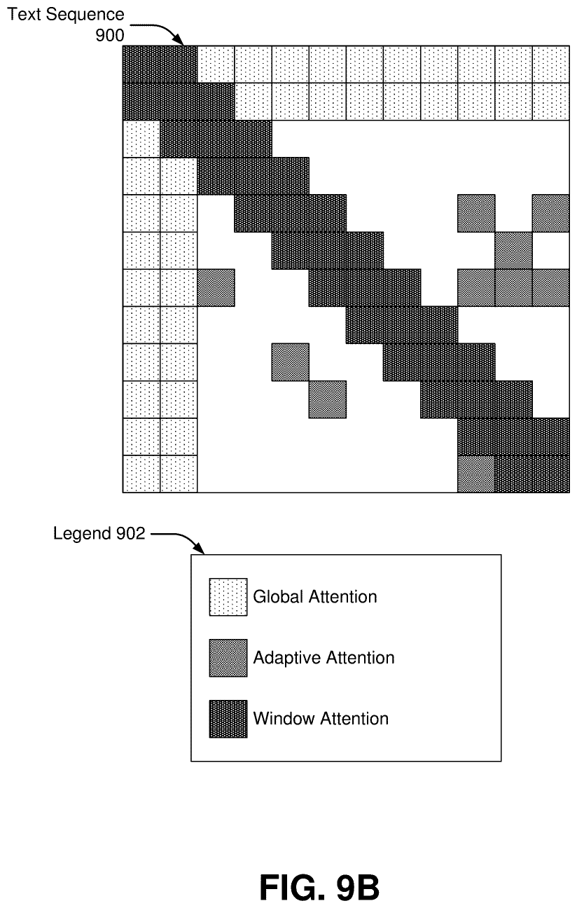

As noted above, some implementations allow for processing of other data modalities besides images. For instance, FIG. 9A shows an example of how a sparse attention approach for modeling text can be modified using the disclosed adaptive sampling approach. (Zaheer, et al., “Big bird: Transformers for longer sequences,” Advances in neural information processing systems, 2022, 33, 17283-17297).

Assume a text sequence is received that includes a sequence of tokens. Attention map 900, shown in FIG. 9A, illustrates how sparse self-attention can be implemented for other tokens in the sequence relative to a currently-processed token. As shown in legend 902, global attention is employed for a subset of tokens that attend over all other tokens entire text sequence. Window attention is employed for tokens within a specified distance from the currently-processed tokens, e.g., a specified number of preceding and subsequent tokens in the sequence. Adaptive attention is employed to randomly select other tokens in the sequence that have a high probability of matching (e.g., being relevant to) the currently-processed token.

As shown in FIG. 9B, the randomly-attended tokens can be updated in a subsequent sampling iteration. Here, the randomly-attended tokens are starting to cluster together in an area of higher probability, e.g., of tokens that have higher probabilities of matching the token being currently processed. Thus, for instance, consider a text sequence with two sentences: “The dog ate the chicken in the kitchen yesterday while I was at work. I forgot to put the gate up to keep the dog out, and he snuck into the room and got them from the counter.” Here, if the word “kitchen” is the currently-processed token, the tokens “dog,” “chicken,” and “leftovers” might have relatively lower self-attention values than the words “room” and “counter.” Thus, over several random sampling sequencies, the self-attention sampling for the word “kitchen” might tend to preferentially select tokens in the second sentence over tokens in the first sentence. Thus, even though some related tokens may be missed in the initial processing layers, the adaptive probability will likely detect the relevant tokens in the subsequent layers.

In other cases, natural language text can be adaptively sampled using cross-attention techniques. For instance, given a natural language question and a large corpus of many documents, the adaptive sampling approach described herein can be employed to determine sampling probabilities for individual tokens in the corpus. The sampling probabilities can be based on confidence scores reflecting the likelihood that a given token in the corpus is part of an answer to the received question. Thus, over several iterations, the attention computations could gradually begin to focus more on relevant documents, chapters, paragraphs, and/or sentences in the corpus that likely relate to the question being asked, while performing fewer attention computations on other documents, chapters, paragraphs, and/or sentences that are unlikely to relate to the question being asked. The final confidence scores can then be employed to select the final answer from the corpus.

### Technical Effect

The disclosed concepts can be employed to efficiently perform sparse attention computations for a broad range of applications. While transformer-based models were used as examples herein, sparse attention sampling can also be implemented in other model structures, such as recurrent networks, using the disclosed techniques. As noted above, sparse attention sampling can be implemented for both cross-attention calculations for separate data sequences as well as self-attention calculations within a single data sequence.

Generally, the disclosed concepts can reduce the use of computational resources significantly compared to dense attention approaches. In addition, the disclosed concepts can accurately identify very small matching portions of a data sequence, whereas alternative sparse attention techniques often fail to identify very small portions of a given data sequence. For example, in the specific example of transformer-based object segmentation model 100, the latent query vectors are updated using attention computations on a relatively small, high-probability subset of pixels of the input image. The updated latent query vectors then are able to focus on relevant features of the input image, including pixels other than those that were employed for the attention computations. As a consequence, the model is able to determine final confidence scores that can be employed to effectively segment out a very small matching object in the input image. In addition, the use of a temperature parameter that decreases over sampling iterations can effectively implement a reinforcement learning approach to attention computations. By starting with a high temperature in early sampling iterations, the disclosed concepts can focus on exploring large areas of an input sequence. As the temperature is cooled over subsequent sampling iterations, the model begins to exploit learned knowledge and focus more on relatively promising areas of a given sequence that are likely to match a prompt.

### Example Backbone Model

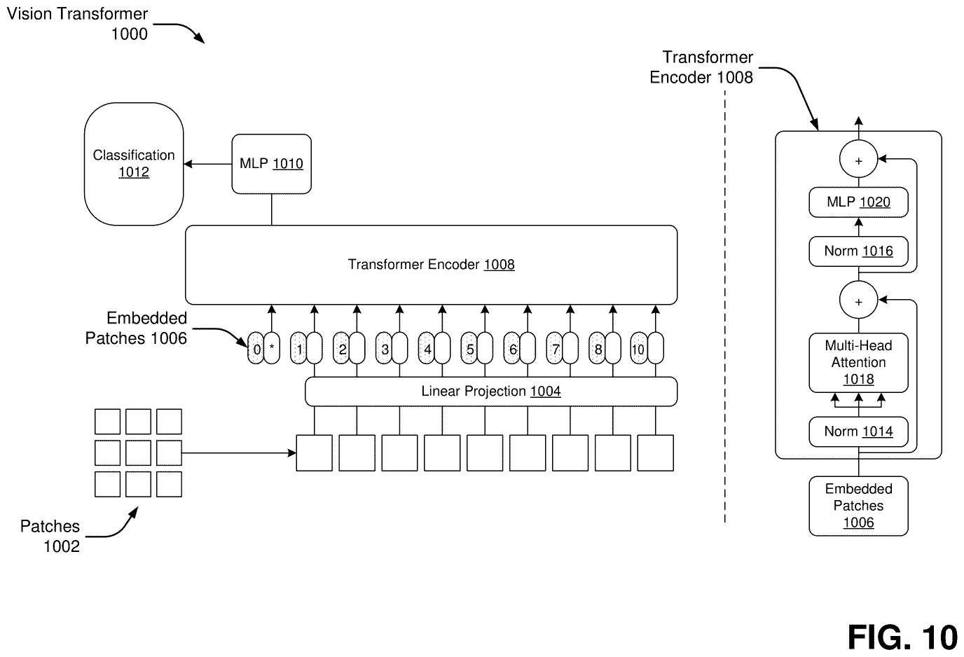

FIG. 10 shows a vision transformer 1000 that can be employed as a backbone (Dosovitskiy, et al., “An image is worth 16×16 words: Transformers for image recognition at scale,” 2020, arXiv preprint arXiv:2010.1110210). The vision transformer receives patches from an image 1002, performs a linear projection 1004 on the patches, and inputs resulting embedded patches 1006 into a transformer encoder 1008. The output of the transformer encoder is processed using a multi-layer perceptron 1010, resulting in a classification 1012.

For example, some implementations can reshape an image into a sequence of flattened pixel patches at one or more resolutions. An embedding can be added to the sequence of embedded patches, and the transformer encoder 1008 can modify that embedding for processing by the multi-layer perceptron 1010.

The transformer encoder 1008 utilizes norm 1014 and norm 1016 to implement layer normalization processing that normalizes features. Multi-head attention layer 1018 can determine dependencies between individual image patches by computing attention scores between respective patches. MLP layer 1020 can process normalized outputs of the multi-head attention layer that can introduce non-linearity into the model and learn relationships between features received from the multi-head attention layer. Multiple transformer blocks can be provided, with each having respective multi-head self-attention, layer normalization, and/or multi-layer perceptron layers.

The vision transformer 1000 can be trained using a supervised learning approach, where a classification head is employed to predict class labels of images. The vision transformer parameters can be updated using a loss function such as cross-entropy loss. Once trained, the vision transformer can process input images to extract visual features that are useful for various downstream tasks, such as object segmentation as described above. Note that other backbone models can also be employed, such as convolutional backbone models like ResNet, MobileNet, etc.

### Example Pixel Decoder

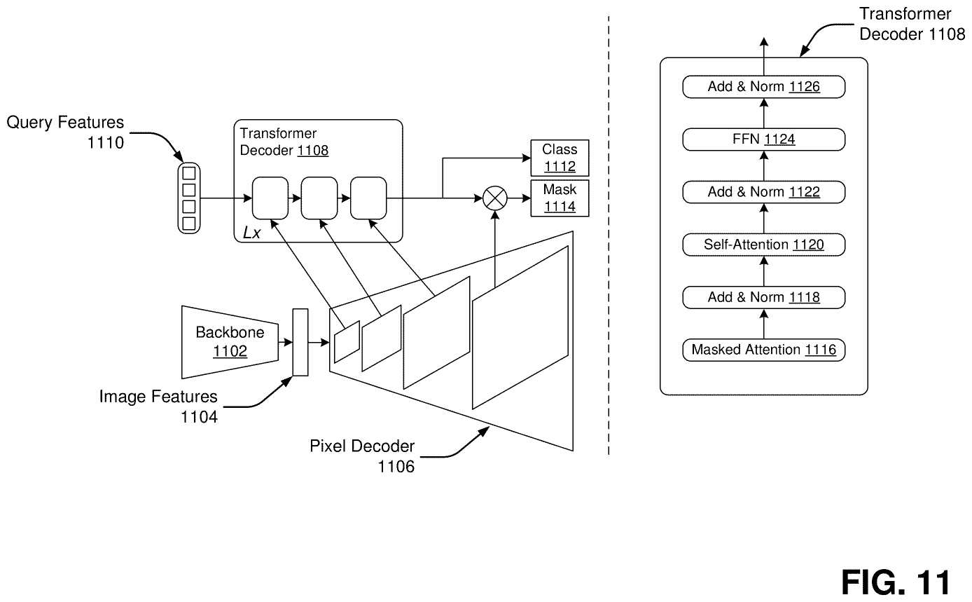

FIG. 11 illustrates how a pixel decoder can be employed with a backbone. (Cheng, et al., “Masked-Attention Mask Transformer for Universal Image Segmentation,” Proceedings of the IEEE/CVF Conference on Computer Vision and Pattern Recognition, 2022, pp. 1290-1299). A backbone 1102 (such as vision transformer 1000, a convolutional backbone, etc.) can extract image features 1104 from an image. A pixel decoder 1106 can upsample features 1104 at progressively higher resolutions using a transformer decoder 1108. The transformer coder receives query features 1110 and outputs a class 1112 and a mask 1114 for an object having that class.

The transformer decoder 1108 can employ a masked attention layer 1116 that attends to the foreground region of the predicted mask for a given query. Add & norm layer 1118 can add a residual connection and normalize features output by the masked attention layer. Self-attention layer 1120 calculates attention weights to determine relationships in sequences received from the preceding layers. Add & norm layer 1122 adds a residual connection and normalizes features output by the self-attention layer. FFN 1124 (feed-forward network) can transform the features for use in segmentation. Add & norm layer 1126 can add a residual connection and normalize features received from preceding layers. The resulting outputs can be used to determine a predicted mask and/or classification for each object in an image.

### Example Text Encoder

In some implementations, a text encoder such as BERT can be employed (Devlin, J., “Bert: Pre-training of deep bidirectional transformers for language understanding,” 2018, arXiv preprint arXiv:1810.04805). For instance, a text encoder such as BERT, trained on a corpus of text documents, might be utilized in instances when the data sequence and the prompt are both textual.

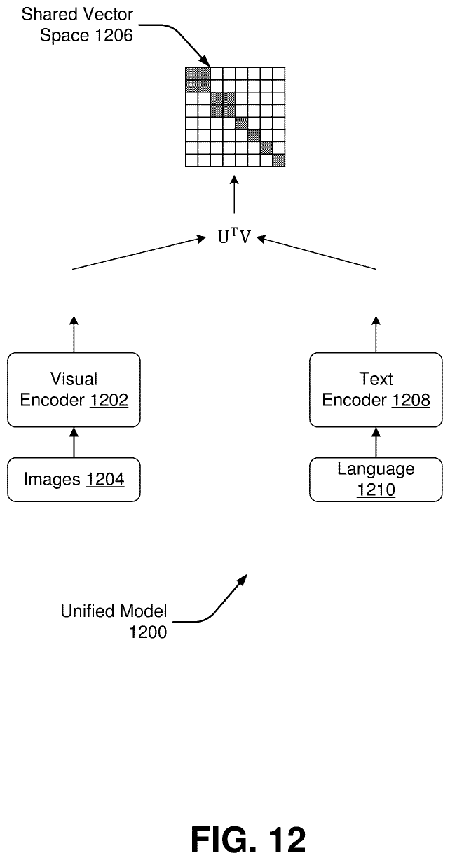

In other implementations, particularly where the data sequence is taken from an image and the prompt is taken from text, the text encoder can be implemented using a model that maps both images and text to a shared space. FIG. 12 illustrates a unified model 1200 that employs a visual encoder 1202 to map images 1204 to a shared vector space 1206. The unified model also includes a text encoder 1208 that maps language input 1210 to the shared vector space. Unified model 1200 can be implemented as described (Yang, et al., “Unified contrastive learning in image-text-label space,” 2022, Proceedings of the IEEE/CVF Conference on Computer Vision and Pattern Recognition, pp. 19163-19173).

For instance, unified model 1200 can be trained using images labeled with class labels as well as images labeled with natural language textual descriptions. The model can be trained to map both images and their text descriptions to locations in the embedding space that are relatively close to one another. As a consequence, the embeddings learned by unified model 1200 may be useful for multi-modal tasks such as object segmentation based on text prompts.

### Device Implementations

As noted above with respect to FIG. 7, system 700 includes several devices, including a client device 710, a client device 720, a server 730, and a server 740. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore and, when executed, can cause a processor to perform acts. The term “system” as used herein can refer to a single device, multiple devices, etc.

Storage resources can be internal or external to the respective devices with which they are associated. The storage resources can include any one or more of volatile or non-volatile memory, hard drives, solid state drives, flash storage devices, and/or optical storage devices (e.g., CDs, DVDs, etc.), among others. As used herein, the terms “computer-readable media” and “computer-readable medium” can include signals. In contrast, the terms “computer-readable storage media” and “computer-readable storage medium” excludes signals. Computer-readable storage media includes “computer-readable storage devices.” Examples of computer-readable storage devices include volatile storage media, such as RAM, and non-volatile storage media, such as hard drives, optical discs, solid state drives, flash memory, etc.

In some cases, the devices are configured with a general-purpose hardware processor and storage resources. Processors and storage can be implemented as separate components or integrated together as in computational RAM. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), neural processing units (NPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

### ADDITIONAL EXAMPLES

Various examples are described above. Additional examples are described below. One example includes a computer-implemented method comprising a prompt relating to a data sequence and performing two or more iterations of: using a machine learning model, determining respective confidence scores that respective portions of the data sequence match the prompt, determining sampling probabilities for the respective portions based at least on the confidence scores, sampling a subset of the portions of the data sequence based at least on the sampling probabilities, and using the machine learning model, performing attention processing on the sampled subset of the portions of the data sequence, the attention processing influencing the confidence scores in a subsequent iteration, using the machine learning model, identifying a matching portion of the data sequence based at least on the confidence scores and outputting the matching portion in response to the prompt.

Another example can include any of the above and/or below examples where the sampling probabilities are taken from a probability distribution having a temperature parameter.

Another example can include any of the above and/or below examples where the method further comprises decreasing the temperature parameter as the two or more iterations are performed.

Another example can include any of the above and/or below examples where the probability distribution is a Boltzmann distribution.

Another example can include any of the above and/or below examples where the data sequence comprises pixels of an image.

Another example can include any of the above and/or below examples where the portions of the data sequence comprise patches of pixels.

Another example can include any of the above and/or below examples where the prompt comprises a text description of an object.

Another example can include any of the above and/or below examples where the matching portion is output as a mask of an object that matches the text description.

Another example can include any of the above and/or below examples where the method further comprises extracting visual features from the image and inputting the visual features to the machine learning model.

Another example can include any of the above and/or below examples where the method further comprises encoding the prompt into one or more text embeddings using a language encoder and inputting the one or more text embeddings to the machine learning model.

Another example can include any of the above and/or below examples where the method further comprises conditioning one or more latent queries on the one or more text embeddings and determining the confidence scores using the one or more latent queries, where the attention processing involves performing cross-attention between the one or more latent queries and visual features for sampled patches of the image.

Another example includes a system comprising a processor and a storage medium storing instructions which, when executed by the processor, cause the system to receive a prompt relating to a data sequence and perform two or more iterations of: using a machine learning model, determine respective confidence scores that respective portions of the data sequence match the prompt, determine sampling probabilities for the respective portions based at least on the confidence scores, sample a subset of the portions of the data sequence based at least on the sampling probabilities and using the machine learning model, perform attention processing on the sampled subset of the portions of the data sequence, the attention processing influencing the confidence scores in a subsequent iteration. The instruction can also cause the system to, using the machine learning model, identify a matching portion of the data sequence based at least on the confidence scores and output the matching portion in response to the prompt.

Another example can include any of the above and/or below examples where the data sequence comprises patches of pixels from an image, the prompt is a natural language description of an object, and the matching portion is output as a mask of pixels classified as corresponding to the prompt.

Another example can include any of the above and/or below examples where the data sequence comprises natural language text.

Another example can include any of the above and/or below examples where the prompt is a natural language question.

Another example can include any of the above and/or below examples where the matching portion is an answer to the question.

Another example can include any of the above and/or below examples where the machine learning model comprises a transformer that performs the attention processing

Another example can include any of the above and/or below examples where the attention processing involves computing cross-attention scores relating the prompt to respective portions of the data sequence.

Another example includes a computer-readable storage medium storing instructions which, when executed by a processing device, cause the processing device to perform acts comprising receiving a prompt relating to a data sequence and performing two or more iterations of: using a machine learning model, determining respective confidence scores that respective portions of the data sequence match the prompt, determining sampling probabilities for the respective portions based at least on the confidence scores, sampling a subset of the portions of the data sequence based at least on the sampling probabilities, and using the machine learning model, performing attention processing on the sampled subset of the portions of the data sequence, the attention processing influencing the confidence scores in a subsequent iteration. The acts can also comprise, using the machine learning model, identifying a matching portion of the data sequence based at least on the confidence scores and outputting the matching portion in response to the prompt.

Another example can include any of the above and/or below examples where the acts further comprise determining the confidence scores using latent queries that are updated in each iteration by the attention processing and aggregating predictions obtained using the latent queries to identify the matching portion of the data sequence.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
receiving a prompt relating to a data sequence;
performing two or more iterations of:
using a machine learning model, determining respective confidence scores that respective portions of the data sequence match the prompt;
determining sampling probabilities for the respective portions based at least on the confidence scores;
sampling a subset of the portions of the data sequence based at least on the sampling probabilities; and
using the machine learning model, performing attention processing on the sampled subset of the portions of the data sequence, the attention processing influencing the confidence scores in a subsequent iteration;
using the machine learning model, identifying a matching portion of the data sequence based at least on the confidence scores; and
outputting the matching portion in response to the prompt.

2. The computer-implemented method of claim 1, wherein the sampling probabilities are taken from a probability distribution having a temperature parameter.

3. The computer-implemented method of claim 2, further comprising:
decreasing the temperature parameter as the two or more iterations are performed.

4. The computer-implemented method of claim 3, the probability distribution being a Boltzmann distribution.

5. The computer-implemented method of claim 1, wherein the data sequence comprises pixels of an image.

6. The computer-implemented method of claim 5, wherein the portions of the data sequence comprise patches of pixels.

7. The computer-implemented method of claim 6, wherein the prompt comprises a text description of an object.

8. The computer-implemented method of claim 7, wherein the matching portion is output as a mask of an object that matches the text description.

9. The computer-implemented method of claim 8, further comprising:
extracting visual features from the image; and
inputting the visual features to the machine learning model.

10. The computer-implemented method of claim 9, further comprising:
encoding the prompt into one or more text embeddings using a language encoder; and
inputting the one or more text embeddings to the machine learning model.

11. The computer-implemented method of claim 10, further comprising:
conditioning one or more latent queries on the one or more text embeddings; and
determining the confidence scores using the one or more latent queries,
wherein the attention processing involves performing cross-attention between the one or more latent queries and visual features for sampled patches of the image.

12. A system comprising:
a processor; and
a storage medium storing instructions which, when executed by the processor, cause the system to:
receive a prompt relating to a data sequence;
perform two or more iterations of:
using a machine learning model, determine respective confidence scores that respective portions of the data sequence match the prompt;
determine sampling probabilities for the respective portions based at least on the confidence scores;
sample a subset of the portions of the data sequence based at least on the sampling probabilities; and
using the machine learning model, perform attention processing on the sampled subset of the portions of the data sequence, the attention processing influencing the confidence scores in a subsequent iteration;
using the machine learning model, identify a matching portion of the data sequence based at least on the confidence scores; and
output the matching portion in response to the prompt.

13. The system of claim 12, wherein the data sequence comprises patches of pixels from an image, the prompt is a natural language description of an object, and the matching portion is output as a mask of pixels classified as corresponding to the prompt.

14. The system of claim 12, wherein the data sequence comprises natural language text.

15. The system of claim 14, wherein the prompt is a natural language question.

16. The system of claim 15, wherein the matching portion is an answer to the question.

17. The system of claim 12, the machine learning model comprising a transformer that performs the attention processing.

18. The system of claim 12, wherein the attention processing involves computing cross-attention scores relating the prompt to respective portions of the data sequence.

19. A computer-readable storage medium storing instructions which, when executed by a processing device, cause the processing device to perform acts comprising:
receiving a prompt relating to a data sequence;
performing two or more iterations of:
using a machine learning model, determining respective confidence scores that respective portions of the data sequence match the prompt;
determining sampling probabilities for the respective portions based at least on the confidence scores;
sampling a subset of the portions of the data sequence based at least on the sampling probabilities; and
using the machine learning model, performing attention processing on the sampled subset of the portions of the data sequence, the attention processing influencing the confidence scores in a subsequent iteration;
using the machine learning model, identifying a matching portion of the data sequence based at least on the confidence scores; and
outputting the matching portion in response to the prompt.

20. The computer-readable storage medium of claim 19, the acts further comprising:
determining the confidence scores using latent queries that are updated in each iteration by the attention processing; and
aggregating predictions obtained using the latent queries to identify the matching portion of the data sequence.
